(19) United States
(12) Patent Application Publication
(10) Pub. No.: US 2017/0242450 A1
(43) Pub. Date: Aug. 24, 2017

(54) ENERGY MANAGEMENT SYSTEM

(71) Applicant: PRINCETON POWER SYSTEMS, INC., Lawrenceville, NJ (US)

(72) Inventors: Martin BECKER, Princeton Junction, NJ (US); Frank HOFFMAN, Princeton, NJ (US); Yevgeniy KOCHEROV, Bloomfield, NJ (US)

(21) Appl. No.: 15/518,657

(22) PCT Filed: Oct. 16, 2015
(86) PCT No.: PCT/US2015/055910

§ 371 Date: Apr. 12, 2017

Related U.S. Application Data
(60) Provisional application No. 62/065,420, filed on Oct. 17, 2014.

(51) Int. Cl. G05F 1/66; G05B 15/02

(52) U.S. Cl. CPC G05F 1/66; G05B 15/02

(57) ABSTRACT

Systems, methods, and apparatus embodiments are described herein for designing, implementing, and maintaining energy systems, such as microgrids for example.

### CROSS REFERENCE TO RELATED APPLICATIONS

This Application claims the benefit of U.S. Provisional Patent Application Ser. No. 62/065,420, filed Oct. 17, 2014, the disclosure of which is hereby incorporated by reference as if set forth in its entirety.

### TECHNICAL FIELD

The present invention relates to the field of energy management.

### BACKGROUND

Designing an electrical power microgrid is often a complicated and expensive engineering project. Power systems, for example microgrids, are often tailored to specific site needs, which can vary based on load patterns, availability of energy resources (e.g., PV, wind, diesel fuel, hydropower, etc.), and the like. A typical microgrid may consist of multiple components such as, for example, generators, inverters, batteries, or the like. The components of a microgrid may be centrally controlled. For example, microgrid systems may include multiple power generation sources that are integrated with each other to efficiently meet various needs of a local load profile. Thus, microgrids are often unique with respect to each other, and the final result of a microgrid design generally has to be tuned after installation.

Currently, designing a general purpose energy system, and in particular a microgrid system or a grid-connected energy system capable of converting into a microgrid, is a grounds-up engineering project. Thus, approaches to implementing and maintaining the designs are typically cumbersome and inefficient.

### SUMMARY

Systems, methods, and apparatus embodiments are described herein for designing, implementing, and maintaining energy systems, such as microgrids for example. In one embodiment, an energy management system includes a computer system that includes one or more processors and a display configured to display images that are representative of an energy system, such as an electrical power generation and transmission system for example. The computer system, and thus the energy management system, further includes a communication interface between the energy system and the processors, and a library of one or more device drivers. Each of the one or more device drivers may be configured to control a respective device. The computer system further includes at least one memory having stored instructions that, upon execution by the one or more processors, cause the computer system to perform operations. The operations may include receiving one or more inputs, for instance a first input, that activates a first design of the energy system. The first design may include a first set of devices. In response to receiving the first input, the computer system may instantiate the device drivers from the library that corresponds to the first set of devices to control, via the communication interface, the first set of devices in the first design of the energy management system.

### BRIEF DESCRIPTION OF THE DRAWINGS

The summary, as well as the following detailed description, is further understood when read in conjunction with the appended drawings. For the purpose of illustrating the disclosure, there are shown in the drawings exemplary embodiments of the disclosure; however, the disclosure is not limited to the specific methods, compositions, and devices disclosed. In addition, the drawings are not necessarily drawn to scale. In the drawings:

FIG. 1 is a block diagram of an energy management system that includes an energy management operating system according to an example embodiment;

FIG. 2A depicts another block diagram of the energy management system shown in FIG. 1, with additional detail depicted;

FIG. 2B is a block diagram of an example energy system that can be controlled by the energy management system of FIG. 2A;

FIG. 2C is an example process flow that can be performed by the energy management system illustrated in FIG. 2A with the energy system depicted in FIG. 2B;

FIG. 3 depicts an example thread that can be generated inside a core application of the energy management system;

FIG. 4 is a flow diagram that can be implemented using a configuration tool of the energy management system;

FIG. 5 depicts the configuration tool characterized in FIG. 4;

FIG. 6 is a flow diagram for adding a new device driver to the energy management system;

FIG. 7 is a flow diagram of a method that can be performed by a constructor function of the energy management system;

FIG. 8 a flow diagram of a method that can be performed by a periodic timer function of the energy management system;

FIGS. 9A-C depict example screen shots that can be displayed by the energy management system;

FIG. 10 depicts an example monitoring table associated with an individual component of an example energy system; and

FIG. 11 is a block diagram of an example computing system in which aspects of the energy management operating system may be embodied.

### DETAILED DESCRIPTION OF ILLUSTRATIVE EMBODIMENTS

The present disclosure may be understood more readily by reference to the following detailed description taken in connection with the accompanying figures and examples, which form a part of this disclosure. It is to be understood that this disclosure is not limited to the specific devices, methods, applications, conditions or parameters described and/or shown herein, and that the terminology used herein is for the purpose of describing particular embodiments by way of example only and is not intended to be limiting of the claims. Also, as used in the specification including the appended claims, the singular forms “a,” “an,” and “the” include the plural, and reference to a particular numerical value includes at least that particular value, unless the context clearly dictates otherwise.

The term “plurality”, as used herein, means more than one. When a range of values is expressed, another embodiment includes from the one particular value and/or to the other particular value. Similarly, when values are expressed as approximations, by use of the antecedent “about,” it will be understood that the particular value forms another embodiment. All ranges are inclusive and combinable. Any documents cited herein are incorporated herein by reference in their entireties for any and all purposes.

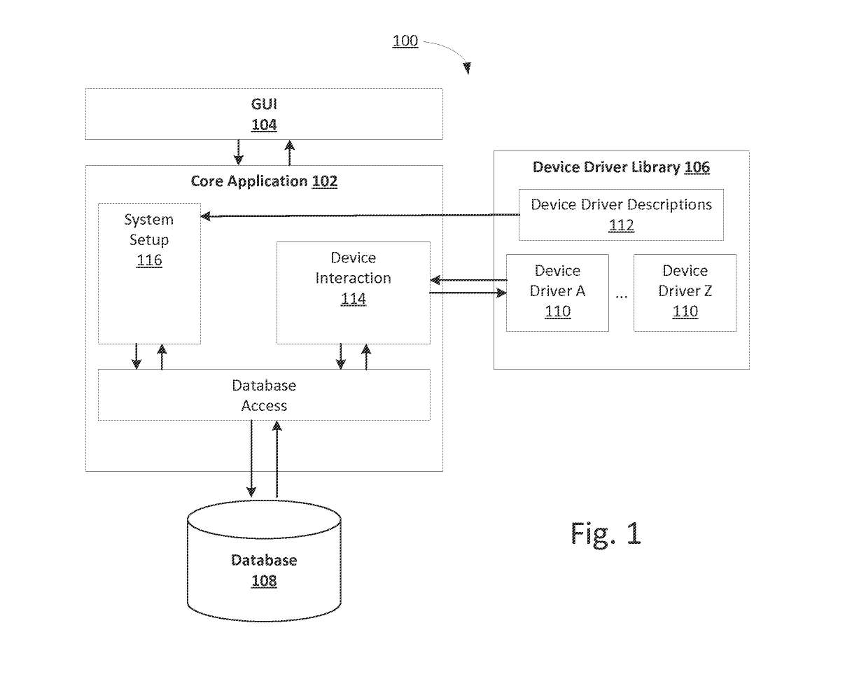

FIG. 1 is a block diagram of an energy management computer system 100 according to an example embodiment. In accordance with the illustrated embodiment, the computer system 100 includes a core application 102, a graphical user interface (GUI) 104, a device driver library 106, and a database 108. The core application 102, which may also be referred to as an energy management operating system (EMOS) 102, of the computer system 100 may be a software module executing on a processor of the energy management system 100. The computer system 100 may include one or more processors and software modules executing on the processors that can be used to design, implement, and monitor various energy management systems, as further described below. It will be appreciated that the example system 100 is simplified to facilitate description of the disclosed subject matter and is not intended to limit the scope of this disclosure. Other devices, systems, and configurations may be used to implement the embodiments disclosed herein in addition to, or instead of, a system such as the system 100, and all such embodiments are contemplated as within the scope of the present disclosure.

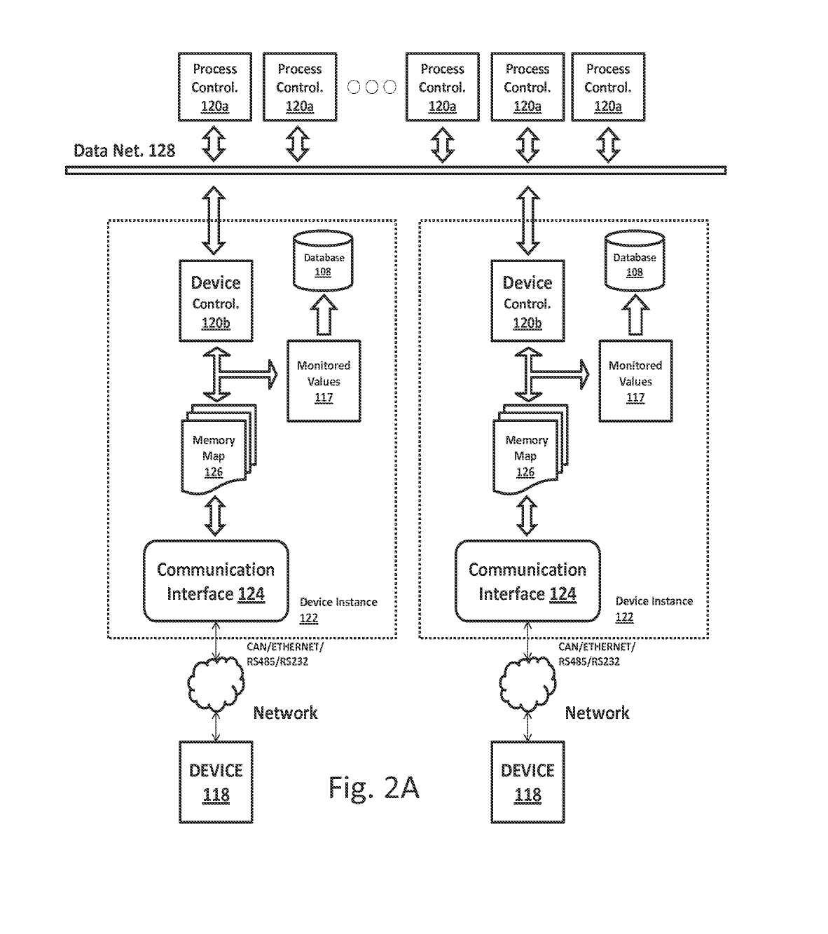

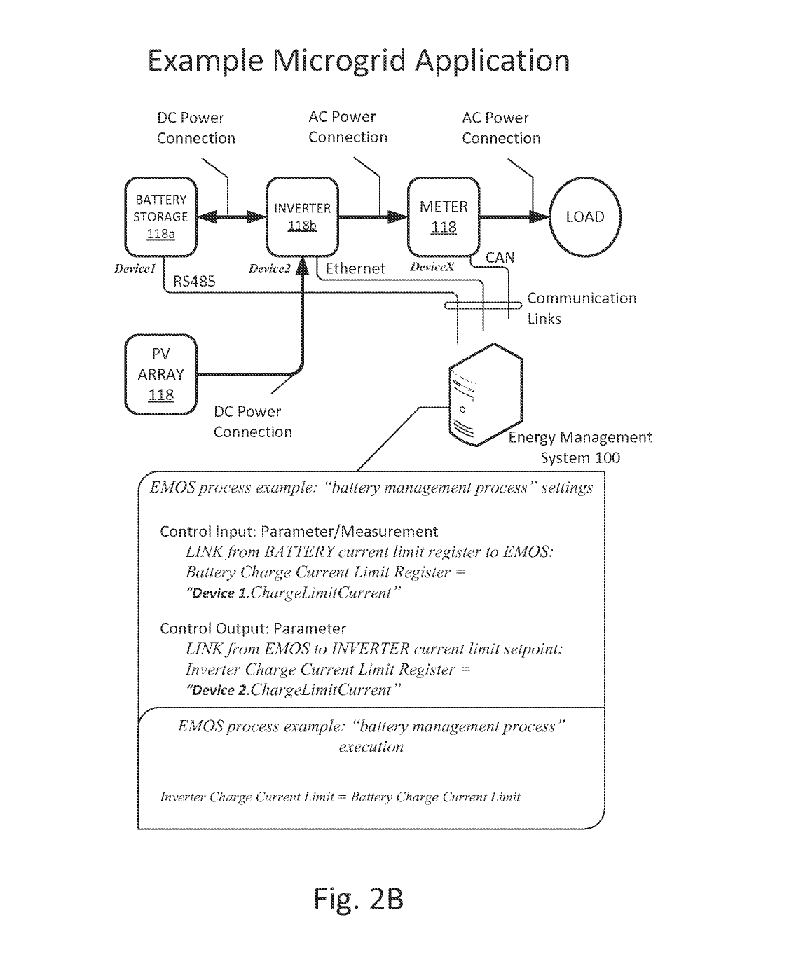

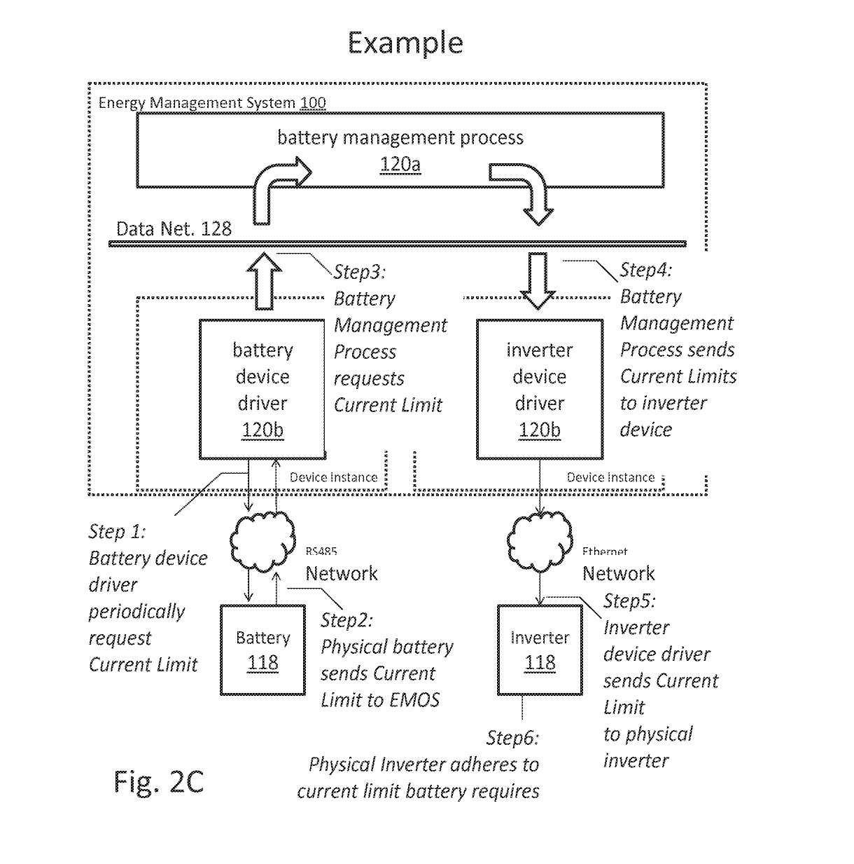

Referring also to FIG. 2, and in particular to FIG. 1, the energy management computer system 100, which may also be referred to generally as an energy management system 100, without limitation, may include a display that is configured to display images representative of an energy system. As used herein, an energy management system, unless otherwise specified, refers to a system that may be used by operators of electric grids and/or microgrids to monitor, control, and/or optimize the performance of an energy system. As used herein, an energy system, unless otherwise specified, generally refers to an electrical generation and/or transmission system. Thus, the described herein energy management computer system 100 may be referred to as a control system that controls electrical infrastructure that produces and distributes power. The energy management system 100 may monitor and control any electrical system, such as a microgrid or another power system configured to produce and distribute electrical power. The display of the energy management computer system 100 can display the GUI 104, which can be used by a user of the system 100 to interact with the system 100. For example, via the GUI 104, the user can design (configure) a particular energy system, control the energy system, and monitor the energy system. By way of example, as further described below, an energy system can be controlled by changing parameters associated with various devices, for instance one or more devices 118 (FIG. 2) within the energy system while the energy system is operational. The energy management system 100, and in particular the GUI 104, can display parameters associated with the devices 118 within an energy system, such that a user can monitor and evaluate the performances of the respective devices. The system 100 can export such parameters for off-line data analysis or for storage.

As shown, the energy management computer system 100 includes the device driver library 106, which can be a library of one or more device drivers 110. The functionality of each device that is known by the core application 102 can be included in one of the device drivers 110 that is associated with a respective device. Thus, each of the one or more device drivers 110 in the library 106 can be configured to control a respective device 118 in an energy system. An example energy system may include various types of devices 118, and thus the library 106 may include various types of drivers 110. An energy management system may include devices that form an abstraction of and interact with specific hardware devices 118, such as power inverters, generators, batteries, or energy meters for example. For example, one or more of the device drivers 110 can be configured to control a respective device 118. An energy system may include devices that enable communication infrastructure, which can allow devices (e.g., inverter, energy meter) to interact with their matching hardware devices. An energy system may also include process or control devices that perform control functions of one or more devices to implement overarching system functionality. An example control device is a peak-shave controller, which may gather measurements from an energy meter device or an energy storage device. The peak-shave controller may instruct an inverter to export electrical power to a connected electrical grid, for example, to meet a predetermined peak-shaving scheme for a given energy system, which may also be referred to as an installation. In the aforementioned example, the peak-shave controller may use communication infrastructure devices to communicate with various devices, such as an energy meter device, an energy storage device, an inverter, or the like.

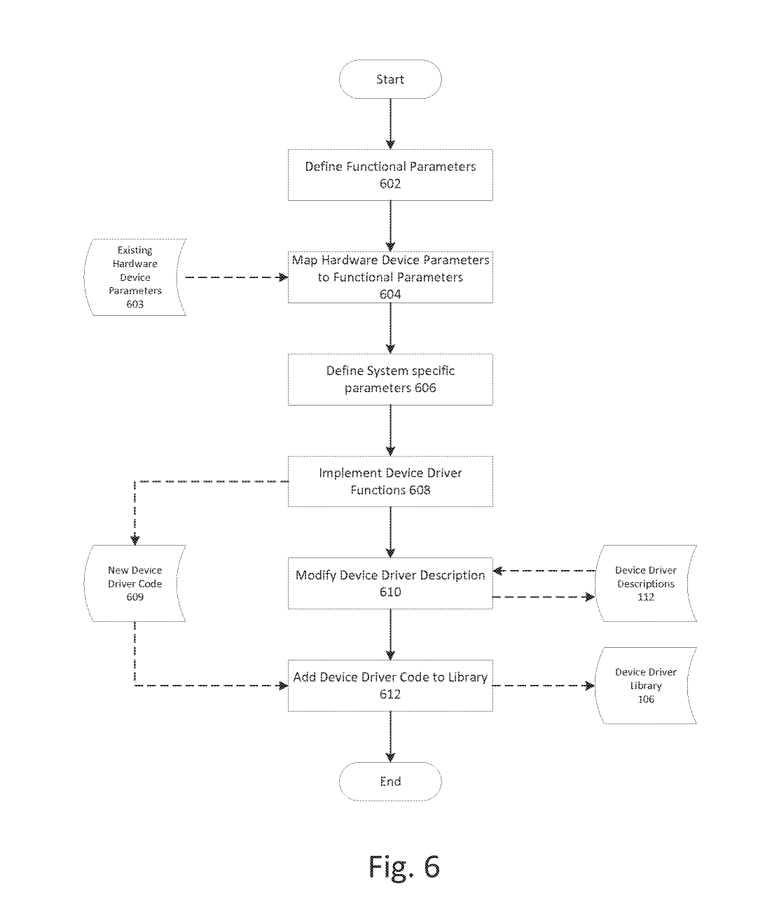

With continuing reference to FIG. 1, each of the drivers 110 may provide a set of software routines that define the behavior of the driver 110. The drivers 110 may define specific functions of respective devices 118 such that the core application 102 can call the specific functions of the devices, for example, after the devices have been set up for a particular energy system. In one embodiment, the core application 102 and the device driver library 106 are separated from each other such that the energy management computer system 100 is adaptable based on needs of an energy system. As further described below with reference to FIG. 6, device drivers for previously unknown devices, control functions, or communication infrastructure can be added to the library 106 of existing device drivers. The device drivers 110 that are available for instantiation within the core application 102 can be identified and described in one or more files, such as a structured text file 112, which can also be referred to generally as device driver descriptions 122, and which can be stored in the device driver library 106.

The core application 102 can perform various interactions, for instance device interactions 114, with instantiated devices for a given energy system. For example, the core application 102 can continuously call a recurring function for each of the device drivers 110 at specified intervals. The core application 102 may further provide system functionality that enables the instantiated device drivers 110 to communicate with existing hardware, and to read or write parameters from other device drivers to perform functions. In one embodiment, the core application 102 communicates with one or more databases, for instance the database 108, to log (store) selected parameters into the database 108. The stored parameters, which may include one or more monitored values 117, may be used to analyze the performance of a given energy system over time. The database 108 may be configured as a structured query language (SQL) database, though it will be appreciated that the database 108 may be alternatively configured as desired. The database 108 can be used to store various information, such as, for example, information that describes a system setup 116, which can also be referred to as a system design or system implementation, of a given energy system. The database 108 can further be used to store information that includes selected parameters for system performance analysis, and the like. In some cases, the information that describes the setup 116 of a given energy system is generated during the setup 116 (design or implementation) of the given energy system. Such information can be stored in the database 108 to allow the core application 102 to read the setup information, and thus instantiate the device drivers 110 that are required by the given energy system, during the start of the core application 102. In some cases, information that includes selected parameters for system performance analysis can be logged into the database 108 continuously during operation of the given energy system. In one example, logging intervals associated with respective device drivers 110 can be defined during the system setup 116. Further, specific parameters of device drivers that should be logged can be identified during the system setup 116. Thus, the core application 102 can log selected parameters at defined intervals.

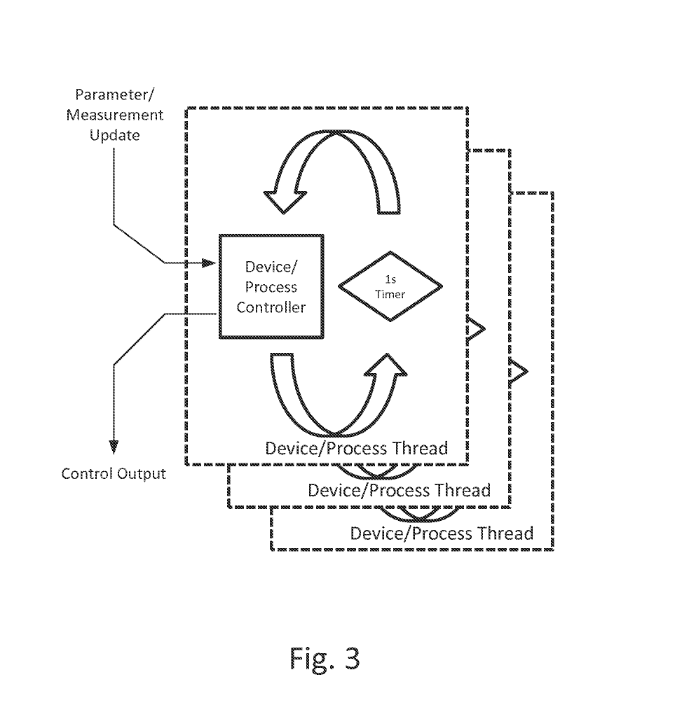

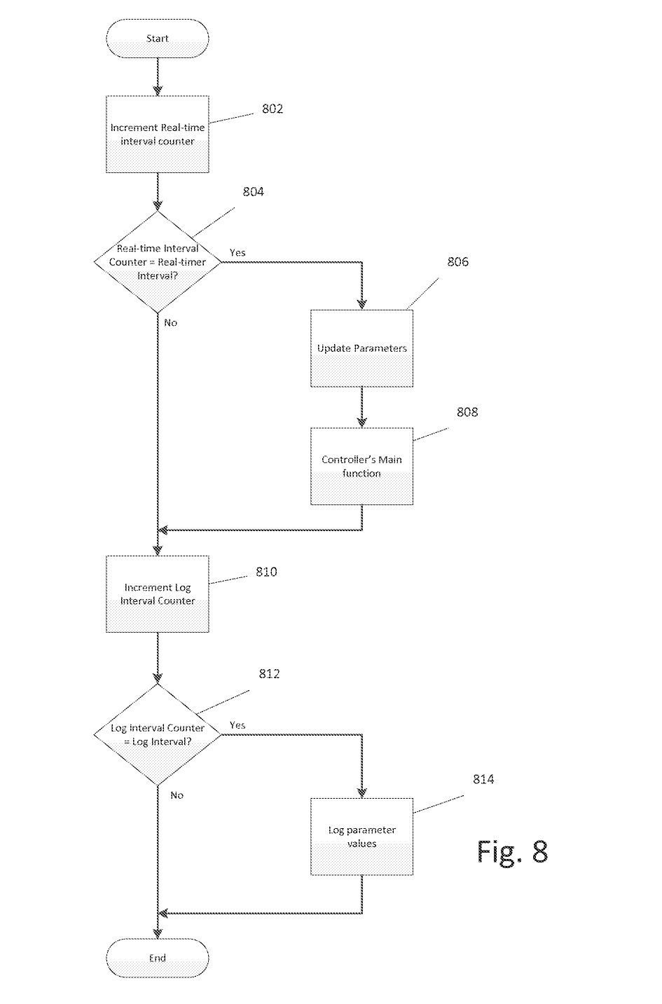

Referring also to FIG. 2A, in operation, the system 100 can control one more devices, for instance devices 118, that are interconnected on a microgrid or a distributed generation site. As described above, the system 100 can include one or more controllers 120, such as processor controllers 120a and device controllers 120b. It will be understood that the system 100 can include any number of process controllers 120a and device controllers 120b as desired. The device controllers 120b can interface with respective devices 118 via a physical communications link. The process controllers 120a can form a link between hardware devices on an energy system, such as a distributed power system for example. As further described below, an instance of a device, for example a device instance 122, is generated so as to allow any number of controllers 120 to interact with an energy system. Each of the device instances 122 may be associated with a respective communication interface 124, which may also be referred to as communication handles. In an example embodiment, for each device instance 122, a thread 300 is generated inside the core application 102 (see FIG. 3) so that multiple communications interfaces 124, which may be associated with various timing and latency constraints, can independently interact with their designated hardware devices 118 without having a negative impact on other portions of the energy system. The communication interfaces 124 can be configured to communicate with devices 118, for instance a first device 118, using a plurality of different communication protocols. FIG. 3 shows an example of the parallel nature of the above-described periodic processing of device or process functions using threads. Each device or process, once it is instantiated, may layer another independent thread onto the energy management system 100. Each thread may be used to process measurements (parameter updates) and assert control to the device's/process's outputs. The example ‘device or process controller’ block shown in each thread (or block) shown in FIG. 3 is expanded in FIG. 8, which is described below. In an example embodiment, each device or process has an independent loop, which allows looping through the flow outlined in FIG. 8 to be performed periodically, for instance at least once every second.

In accordance with an example embodiment, each of the devices 118 within an energy system can expose a set of handles that can be used by the process controllers 120a to retrieve measurements and to control parameters. By way of example, one of the devices 118 may be a battery device that is associated with measured parameters, such as, for example, a voltage, a measured current, a current limit, a state of charge, or the like. One of the process controllers 120a may link the battery to another one of the devices 118, such as an inverter device for example. The process controller 120a may request a required charge current instruction from the battery device and pass that to the inverter target charge current command. The process controller 120a may link one or more control parameters from the battery to the inverter through setup parameters of the processor controller 120a.

Referring also to FIG. 2B, an example energy system 200, which may be a microgrid, is shown. The energy system 200 includes a device 118, for instance a battery 118a, connected to another device 118, for instance an inverter 118b. The energy management computer system 100 is communicatively coupled to the devices 118 within the energy system 100. In some cases, the battery 118a has particular current limits that need to be maintained. Because the inverter 118b can control the current, an inverter current setpoint should be within the battery current limits. Such current limits may be communicated to the inverter 118b through the energy management system 100, in particular the energy management operating system. The energy management system 100 may extract current limits from the battery 118a. The energy management system 100 may also process the current limits and provide the inverter 118b that controls the current on the battery 118a with the appropriate current limits.

By way of example, referring also to FIG. 2C, the current limit is measured on a specific hardware device 118, for instance the battery 118a. The current limit is exposed by a battery device controller (driver) 120b to the battery 118a. The current limit may be exposed by the battery device driver 120b to a battery process controller 120a, which can also be referred to as a battery management process 120a. Thus, when the example in FIG. 2B is applied to FIG. 2A, the example depicted in FIG. 2C may result. Referring in particular to FIG. 2C, the physical battery device 118a is depicted, and the physical inverter 118b may be connected to power terminals of the battery 118a. The battery process controller 120a may take the current limit measurements exposed on the battery device driver 120b, and pass them to an inverter device driver 120b. The inverter device driver 120b may have exposed registers to which the battery management process 120a can use to write the current limits. In an example embodiment, the inverter device driver 120b may then communicate this control limit to the inverter 110b. The physical inverter 118b may then be able to ensure that it uses the battery 118a within the limits of the battery 118a. For example, the inverter 118b may charge the battery 118a within the limits required by the battery 118a.

For example, a “Battery Charge Current Limit Register” on the battery management process controller 120a may be set to “Device1.ChargeLimitCurrent”, where “ChargeLimitCurrent” is a register name associated with the battery device driver 120b (Device 1) that indicates with how much current the battery 118a can be charged. By way of further example, a setting “Inverter Charge Current Limit Register” on the battery management process controller 120a may be set to “Device2.ChargeCurrentLimit”, where “ChargeLimitCurrent” is also a register name in the inverter device 118b (Device 2) (See FIG. 2B).

When communicating with one of the devices 118, the respective communication interface 124 may need to know one or more attributes associated with the device 118, such as, for example, what communication protocol or what hardware interface the device 118 uses to communicate. In some cases, the communication interfaces 124 can communicate using various conventional standards, such as Ethernet and TCP/IP for example. It is recognized herein, however, that the devices 118 may be associated with unique parameters and may require unique control instructions. Thus, in accordance with an example embodiment, the communication interface 124 is generic such that the communications interface can interact with a variety of devices 118. For example, various communication parameters and their mapping to the actual devices 118 can be defined in various files accessible by the device controllers 120b. As shown, the files can be configured as an XML memory map 126. The XML memory map 126 can be tailored to a specific register mapping. The XML memory map 126 can include an xml file name and path that is linked to the device controllers 120b through settings on the device controllers 120b. As shown in FIG. 2, the processor controllers 120a and the device controllers 120b can interact with each other via a data network 128, which can also be referred to as an internal virtual data network 128. The data network 128 can link the process controllers 120a and the device controllers 120b with each other. In an example embodiment, each of the devices 118 are ‘Masters’ or ‘Clients’ on the internal virtual data network 128, and thus the processor controllers 120a can request parameters from, or command, one or more of the devices 118 when its turn has come (or the thread 300 allows the process or device to refresh its parameters). For example, multiple threads, for instance one for each device or process, may loop periodically (see FIG. 3), and thus may periodically execute the example flow depicted in FIG. 8. It will be understood that the flow may be performed at any desired period. For example, the flow shown in FIG. 8 may execute on a particular device or process once every second.

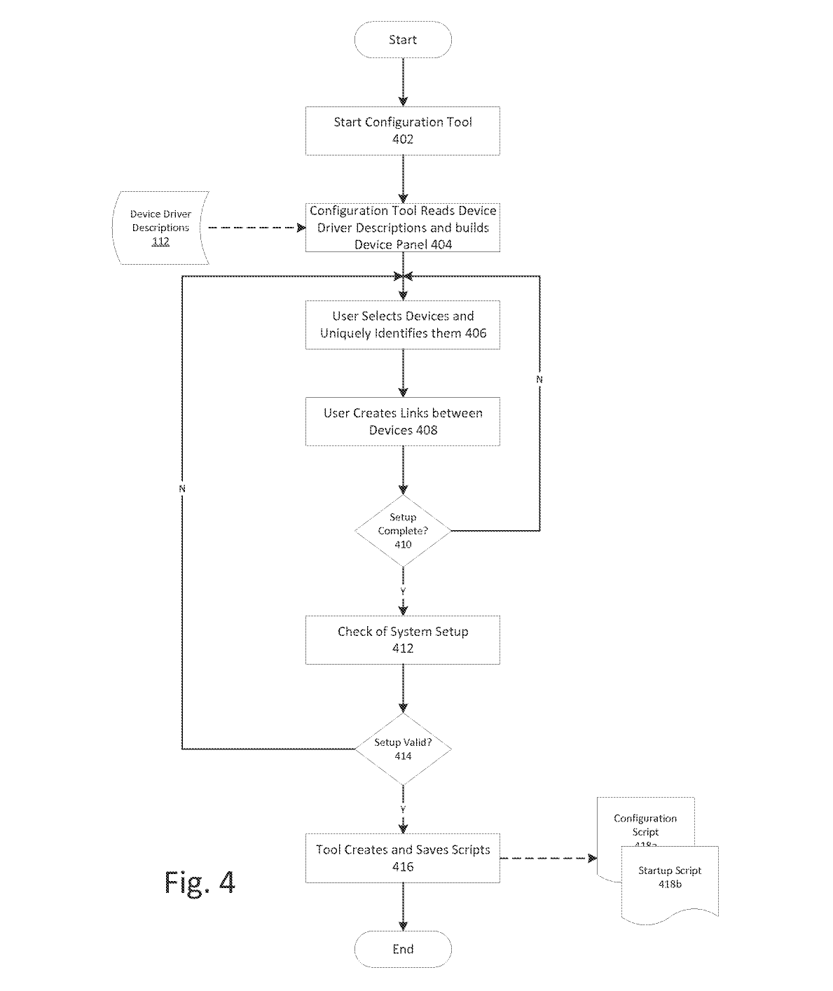

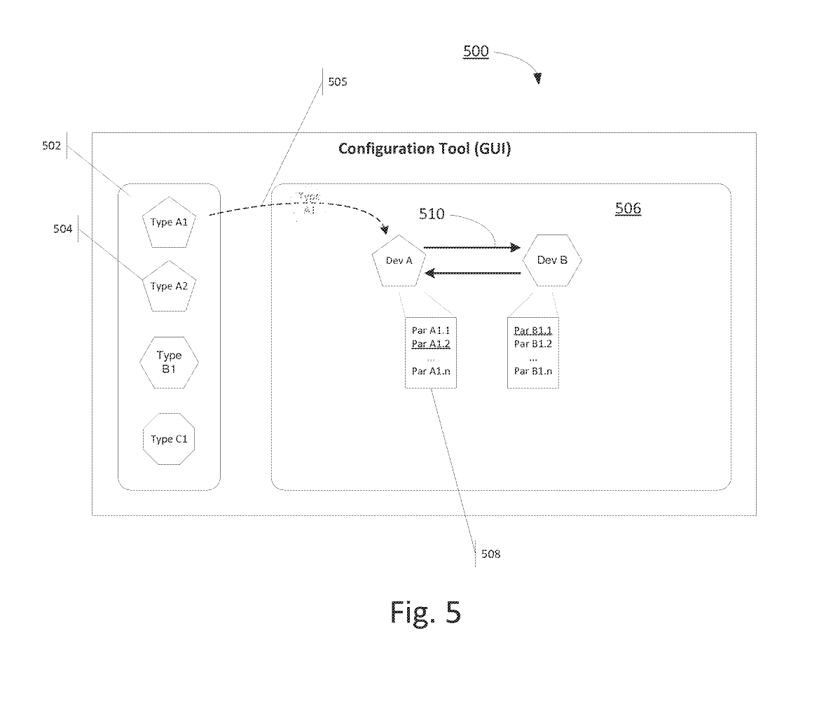

In operation, one or more users can design (setup) an energy system using the system 100. Referring in particular to FIGS. 4 and 5, the GUI 104, and thus the system 100, can include a configuration tool 500, which can also be referred to as a configuration application 500. One or more users can use the configuration tool 500 to setup an energy system or site, such as a microgrid for example.

Referring in particular to FIG. 4, at 402, the configuration tool 500 is started by one or more users. At 404, the configuration tool 500 reads the device driver descriptions 112 and builds a device panel 502 based on the device drivers 110 that are defined in the device driver library 106. For example, at least some up to all of the devices 118 associated with the device drivers 110 that are stored in the device driver library 106 can be displayed in the device panel 502 such that one or more users can select the device 118 that are defined in the device driver library 106. The configuration tool 500 can build the panel 502 at start-up of the configuration tool by reading a device driver list indicative of devices 118 that can be instantiated by device drivers 110 defined in the device driver library 106. It will be understood that the device drivers 110 and/or the devices 118 associated with the device drivers 110 can be arranged by type, model, make, or alternatively arranged as desired in the device panel 502. Thus, users can sort the panel 502 by types of devices in order to efficiently discover which desired devices are available for instantiation by the core application 102. It will further be understood that graphical symbols 504 representative of each device 118, and in particular each type of device 118, can be displayed in the device panel 502. Alternatively, or additionally, text describing each device driver 110 and/or each device 118 can be displayed in the device panel 502.

Still referring to FIGS. 4 and 5, at 406, one or more users can select one or more devices 118 from the panel 502. For example, the user can drag and drop (at 505) a graphical symbol representative of a device from the device panel 502 to a canvas interface 506. The one or more users can further determine an identity for each device that is represented by a graphical symbol on the canvas interface 506. The respective identities of the devices can consist of a number, a textual name, a description, or the like, or a combination thereof. In some cases, at 406, symbols representative of multiple devices of the same type can be selected and placed on the canvas 506, but such devices are given different identities so that the devices can be distinguished from each other. In an example embodiment, system specific parameters are assigned values for each selected device. Default values can further be assigned such that a device definition associated with each selected device is complete.

In accordance with the illustrated embodiment, after devices 118 that are selected for a particular energy system are defined at 406, links between the devices 118 are created, at 408. The links may define device interactions. For example, the links may indicate which parameters are read from other devices or are written to other devices when the energy system operates. Links may be created by identifying the devices 118 that should be linked to each other. Then, the type or direction (e.g., read or write) may be selected for each link. In an example embodiment, after the link type for a link between two devices 118 is defined, a user may select a source parameter and a target parameter from lists of parameters associated with each of the two selected devices (see 508). The process of selecting source-target parameter pairs can be repeated for an example link, for example, if multiple parameters are to be transferred in the same direction. On the canvas interface 506, in accordance with an example embodiment, links between selected devices are indicated by directional symbols, such as arrows 510 for example, that indicate how information is transferred between the select devices 118.

With continuing reference to FIG. 4, in accordance with the illustrated embodiment, once the user has completed the setup, the configuration tool 500 verifies that the setup is complete, at 410. If the setup is not complete, the process may return to step 406, which is described above. If the setup is complete, the process may proceed to step 412, where the configuration tool 500 checks the system setup. At 414, the configuration tool determines whether the system setup, which can also be referred to as the setup design, is valid. By way of example, a setup check may pass when the required links between devices have been entered correctly. In particular, the setup check may pass when the links that were created between devices are still valid at the time the setup is deemed to be complete. In some cases, links may be inadvertently broken by deleting a device from the canvas. Thus, the setup check may identify that links are broken and deem the setup invalid. An appropriate error message may then be rendered, for instance displayed.

If the system setup is not valid, the process may return to step 406, described above. If the system setup is valid, the tool 500 may create and save one or more scripts 418, at 416. In an example embodiment, one or more outputs of the configuration application 500 include scripts 418, which may include text files. Example scripts include a configuration script 418a and a start-up script 418b. In an example embodiment, the configuration script 418a is read and executed by the core application 102. In some cases, the configuration script 418a is executed the first time that the core application 102 is run, for example when no valid system setup is defined in the database 108. In other cases, a user may explicitly request that the configuration script 418a is run. The start-up script 418b may be run each time the core application 102 is started when a valid system setup is stored in the database 108, or when a user explicitly requests that the start-up script 418b be run.

As mentioned above, the energy management computer system 100 can import (or install from a file) device drivers 110, which can be referred to as new device drivers 110, such that the core application 102 can implement previously unknown hardware devices, additional communication infrastructure, or additional control functions, in an energy system. The new device drivers can be imported or installed at any stage that allows the energy management system's core application 102 to implement previously unknown devices, communications protocols, or overarching control processes. For example, a developer can create new device drivers, communication interfaces, or control processes for the energy management system 100 using the example flow depicted in FIG. 6. The development of a new device driver may be done on a software development platform, and then it may be compiled into a file that can be imported and used by the energy management system 100. The energy management system 100 can apply the associated device drivers.

Referring to FIG. 6, in accordance with the illustrated embodiment, at 602, functional parameters are defined for an example hardware device. At 604, a list of existing parameters 603 of the hardware device is mapped to parameters in a software abstraction. For example, depending on the functional requirements of the device, in some cases not all parameters provided by the hardware device need to be used. In addition to the functional parameters, a number of system related parameters may be created at 606. The system parameters may allow interaction of the new device driver with other device drivers. For example, the system parameters may include an example parameter that links the new device to a communication infrastructure device, such one of the communication interfaces 124. At 608, the device driver functions are implemented, which allows the core application 102 to call functions from one of the device drivers 110. At 610, the device driver descriptions 112 in the device driver library 106 is modified to include a description of the new device driver 110 corresponding to the new device 118. Further, at 612, new device driver code 609 can be added to the library 106 that stores the device drivers 110. In an example embodiment, at 610, the device driver description may be based on existing device driver code templates on which a bases the new device driver. Alternatively, the developer can create new device driver code 609 to get to step 612. Step 612 may be executed when the device driver file is imported into the energy management system 100. In some cases, the developer does not modify the device driver library 106 manually. This step may be done automatically by the energy management system 100 when the device driver file is imported or installed into the energy management system 100.

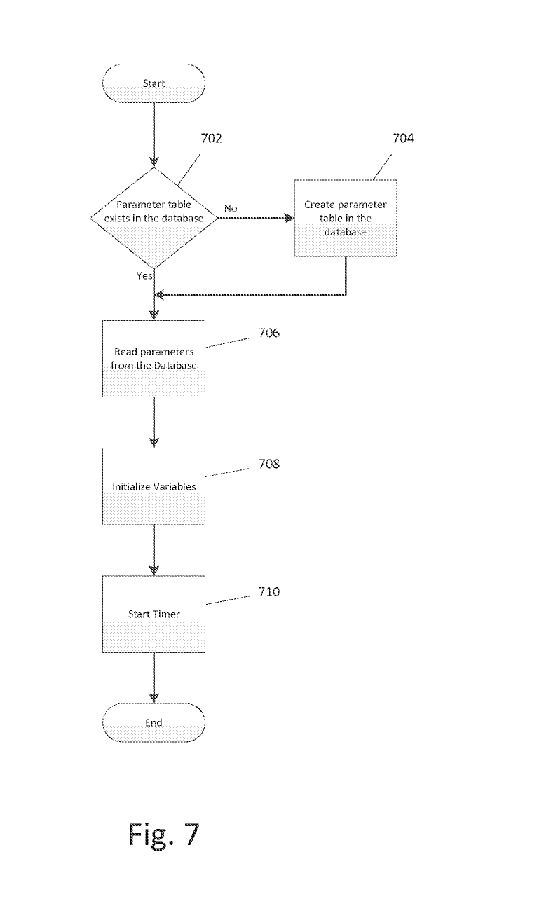

Referring now to FIGS. 7 and 8, the controllers 120, for instance the process controllers 120a and the device controllers 120b, may include a constructor function and a periodic timer function. Referring in particular to FIG. 7, the constructor function may be called when the controller 120 is initialized, for instance during system startup 116. In accordance with the illustrated embodiment, at 702, an example controller 120, and in particular the constructor function of the controller 120, determines whether a table of parameters associated with the controller 120 exists in the database 108. If the table does not exist, the process proceeds to step 704 where the constructor function of the controller 120 creates a table associated with the controller 120 in the database 108. After the table is created, the table may be filled with values, at 706. Similarly, if it is determined, at 702, that the table exists, the constructor function may read the parameters from the database 108 and store values associated with the parameters into variables, at 706. At 708, the controller function initializes the rest of the controller's member variables. At 710, the periodic timer may be started, which is described with reference to FIG. 7.

Referring in particular to FIG. 8, the periodic timer function may run at a predefined constant interval or at an interval specified by one of the controller's parameters. In accordance with the illustrated embodiment, at 802, the periodic timer function starts by incrementing a real-time interval counter. At 804, the periodic timer function determines whether the real-time interval counter is at least equal to the real-timer interval. If the counter reaches the real-timer Interval, which is one of the settings of the controller 120, the periodic timer function may perform an update parameters routine (806) and a main or primary function of the controller 120 (808). During the update parameters routine, the controller 120 determines whether parameters were changed, for example by the user or by another controller. If one or more parameters have changed, the controller 120 may store the changes in the database 108. The main function of the controller 120 that is a process controller 120a refers to an algorithm (e.g., peak shaving) that the process controller 120a. For device controllers 120b, the main function may include a query to the hardware device 118 to retrieve data associated with the device 118. By way of example, a main function of a device controller 120b may include querying a power meter to retrieve power data that the power meter has monitored. At 810, in accordance with the illustrated embodiment, the controller 120 increments a log interval counter. At 812, the controller 120 determines whether the log interval counter is at least equal to the log interval. If the counter reaches a log interval setting, the controller 120, at 814, stores the values of the parameters that were configured for data logging into the database 108 along with the current time stamp.

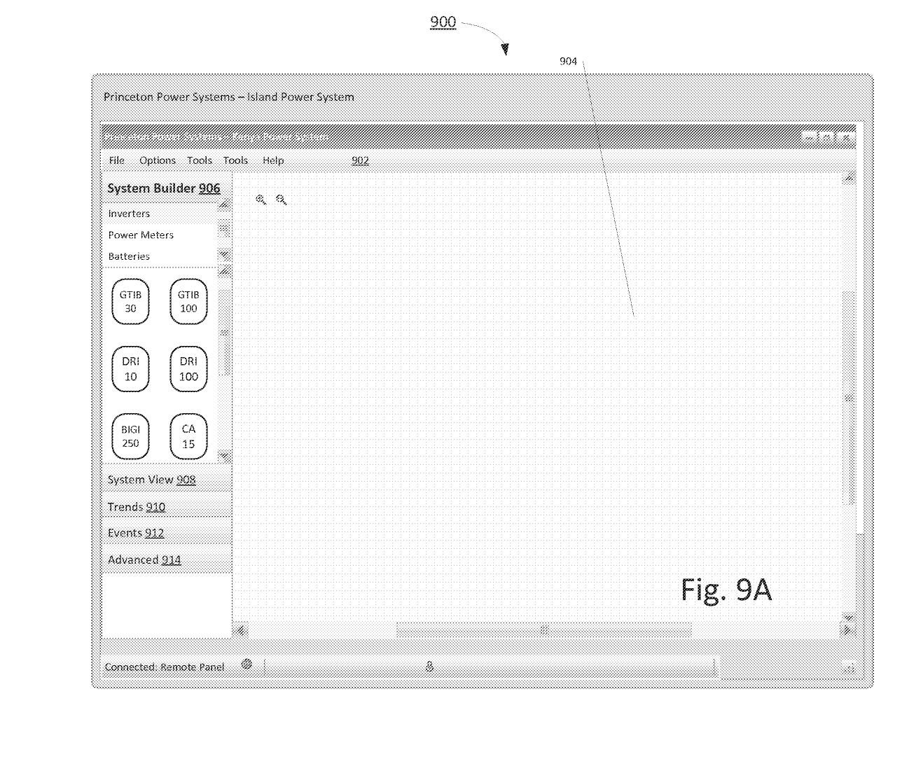

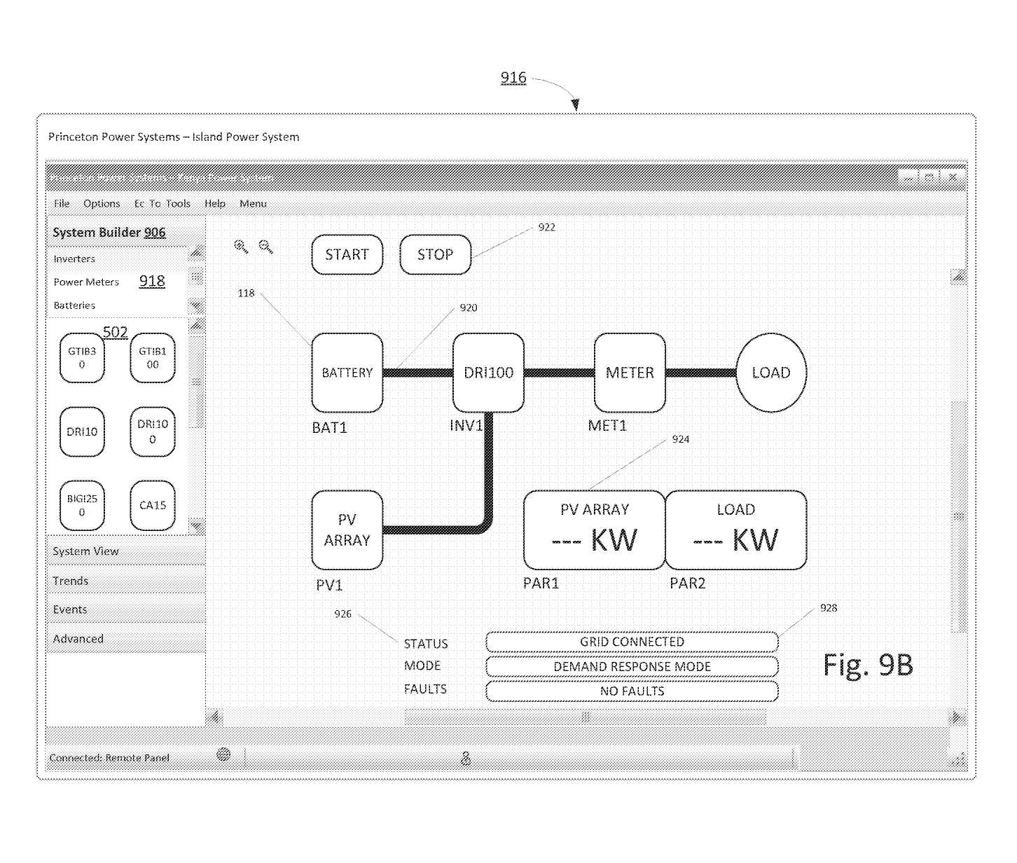

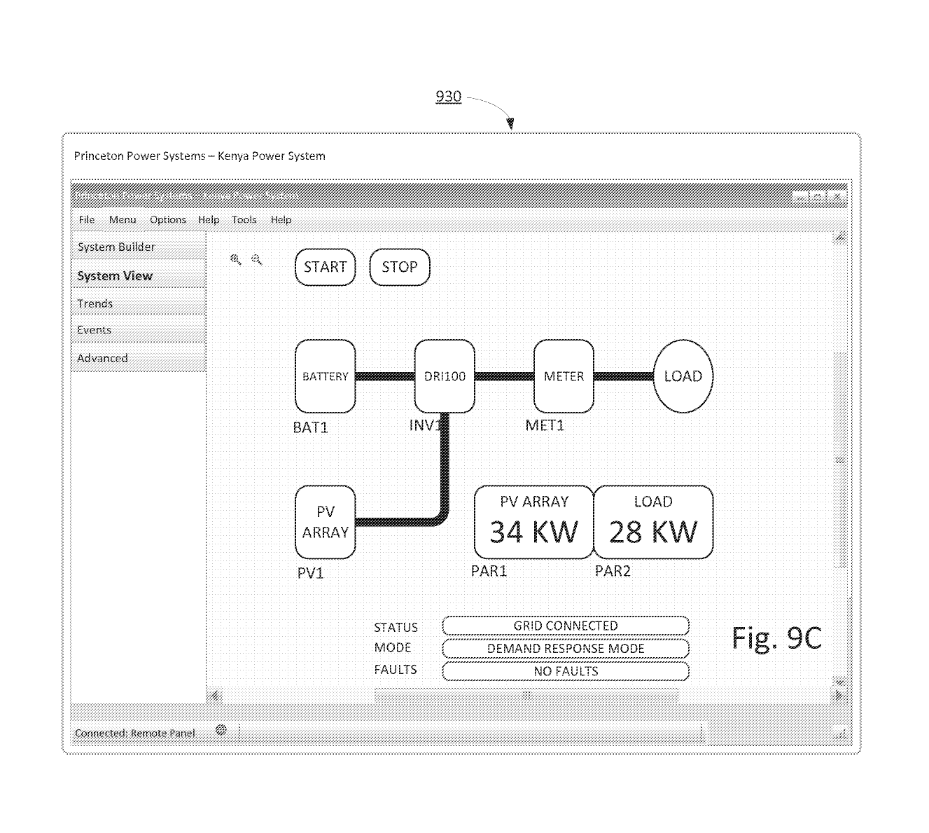

FIGS. 9A-C are example screen shots of the GUI 104 that can be displayed by the system 100, for example, to allow users to interact with an energy system. FIG. 9A depicts an example user interface 900 that includes a menu bar 902, a main panel 904, and the like. A user can use the menu bar 902 to configure options, save/load files, look at help, etc. As shown, the example user interface 900 includes various tabs such as, for example, a System Builder tab 906, a System View tab 908, a trends tab 910, an Events 912, and an Advanced tab 914. It will be understood that the user interface 900 can include other tabs as desired. The System Builder tab 906 may be used to design an energy system, as described above. A user may select and use the System View tab 908 to control and monitor the system. Selecting the Trends tab 910 may allow a user to view historical or real-time data associated with the energy system. Such data may be presented in graphs, charts, or the like. Selecting the event tab 912 may allow a user to view information concerning various events associated with the energy system, such as system faults or alarms for example. The advanced tab 914 may be selected to give a user access to the database 108, for example, to read and/or edit system parameters directly.

Referring in particular to FIG. 9B, an example system builder interface 916 is depicted. The system builder interface may be rendered in the main panel 904 when the system builder tab 906 is selected by a user. Using the System Builder interface 916, a user can create an energy management system that allows the user to control and manage an energy installation. The energy system can be built by dragging and dropping components from the device panel 502, which can also be referred to as the System Builder toolbar 502, into the main panel 904. The components can be organized into groups 918, such as inverters, batteries, meters, algorithms, controls, or the like. In accordance with an example embodiment, after the user selects a particular group, the components within the group are displayed in the device panel 502 below the group names. To build an energy system in accordance with an example embodiment, a user may drag and drop the components based on system requirements. An energy system that is built using the energy management system 100 may consist of various electrical components, such as batteries, inverters, meters, and power sources. In some cases, users can connect such components with one or more lines 920 that represent the power cables. After the user connects the components to design a system, the designed system rendered in the main panel 904 may resemble an electrical diagram. Other components, for example, control buttons 922, readouts 924, text labels 926, and text boxes 928 may be added to the design. Once the complete system is setup, user can double click on each component to edit its settings in accordance with an example embodiment. It will be understood that the settings of a component can be edited by selecting the component using alternative actuations.

Thus, using the system builder interface 916, the energy management computer system 100, which can include at least one memory having stored therein instructions that cause the computer system to perform operations, can receive an input, for instance a first input, that activates a design of an energy system. The design of the energy system can include a first set of devices 118. In response to receiving the first input, the system 100 can instantiate the device drivers 110 from the library 106 that correspond to the first set of devices 118 to control (via the communication interface 124) the first set of devices in the first design of the energy system. As shown in FIG. 9B, an input, such as the first input, can include a one line diagram that includes a plurality of images connected with each other. The plurality of images can be representative of the first set of devices 118 such that each device in the first set of devices is communicatively connected with the other devices in the first set in accordance with the one line diagram.

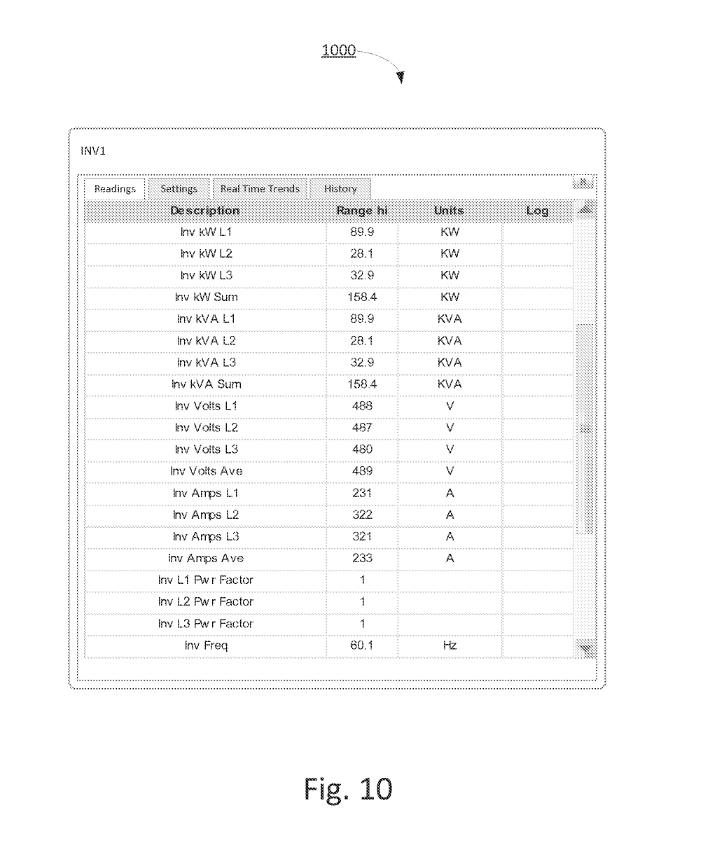

Referring in particular to FIG. 9C, an example system view interface 930 is depicted. Using the system view interface 930, a user may control and monitor the system that was created using the System Builder interface 914. The components in the system view interface 930 are active. Thus, the device controllers 120b communicate with the hardware devices 118, the process controllers 120a (algorithms) perform calculations, the readouts 924 display parameters to which the readouts 924 are linked, and the like. In accordance with an example embodiment, a user can monitor individual components and change the properties of an individual component by double clicking on the graphical representation of the individual component on the main interface 904. Referring to FIG. 10, an example table 1000 is shown that lists properties associated with an example individual component, and in particular an example inverter implemented in an energy system. As shown, a user can view real time data, change settings, view trends, and analyze historical data. Such a view can be referred to as a controller view.

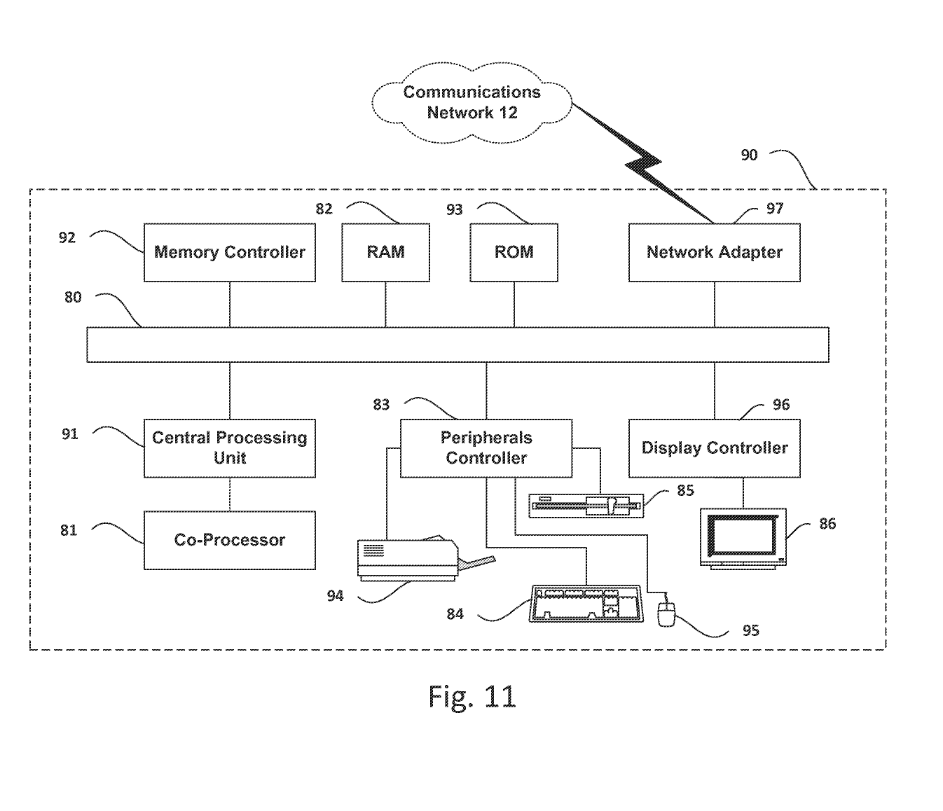

FIG. 11 is a block diagram of an exemplary computing system 90 on which, for example, one or more the embodiments disclosed above may be implemented. Computing system 90 may comprise a computer or server and may be controlled primarily by computer readable instructions, which may be in the form of software, wherever, or by whatever means such software is stored or accessed. Such computer readable instructions may be executed within central processing unit (CPU) 91 to cause computing system 90 to do work. In many known workstations, servers, and personal computers, central processing unit 91 is implemented by a single-chip CPU called a microprocessor. In other machines, the central processing unit 91 may comprise multiple processors. Coprocessor 81 is an optional processor, distinct from main CPU 91, that performs additional functions or assists CPU 91.

In operation, CPU 91 fetches, decodes, and executes instructions, and transfers information to and from other resources via the computer's main data-transfer path, system bus 80. Such a system bus connects the components in computing system 90 and defines the medium for data exchange. System bus 80 typically includes data lines for sending data, address lines for sending addresses, and control lines for sending interrupts and for operating the system bus. An example of such a system bus 80 is the PCI (Peripheral Component Interconnect) bus.

Memory devices coupled to system bus 80 include random access memory (RAM) 82 and read only memory (ROM) 93. Such memories include circuitry that allows information to be stored and retrieved. ROMs 93 generally contain stored data that cannot easily be modified. Data stored in RAM 82 can be read or changed by CPU 91 or other hardware devices. Access to RAM 82 and/or ROM 93 may be controlled by memory controller 92. Memory controller 92 may provide an address translation function that translates virtual addresses into physical addresses as instructions are executed. Memory controller 92 may also provide a memory protection function that isolates processes within the system and isolates system processes from user processes. Thus, a program running in a first mode can access only memory mapped by its own process virtual address space; it cannot access memory within another process's virtual address space unless memory sharing between the processes has been set up.

In addition, computing system 90 may contain peripherals controller 83 responsible for communicating instructions from CPU 91 to peripherals, such as printer 94, keyboard 84, mouse 95, and disk drive 85.

Display 86, which is controlled by display controller 96, is used to display visual output generated by computing system 90. Such visual output may include text, graphics, animated graphics, and video. Display 86 may be implemented with a CRT-based video display, an LCD-based flat-panel display, gas plasma-based flat-panel display, or a touch-panel. Display controller 96 includes electronic components required to generate a video signal that is sent to display 86.

Further, computing system 90 may contain network adaptor 97 that may be used to connect computing system 90 to an external communications network.

It is understood that any or all of the systems, methods and processes described herein may be embodied in the form of computer executable instructions (i.e., program code) stored on a computer-readable storage medium with instructions, when executed by a machine, such as a computer, server, or the like, perform and/or implement the systems, methods and processes described herein. Specifically, any of the steps, operations or functions described above may be implemented in the form of such computer executable instructions. Computer readable storage media include both volatile and nonvolatile, removable and non-removable media implemented in any method or technology for storage of information, but such computer readable storage media do not includes signals. Computer readable storage media include, but are not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other physical medium which can be used to store the desired information and which can be accessed by a computer.

In describing preferred embodiments of the subject matter of the present disclosure, as illustrated in the figures, specific terminology is employed for the sake of clarity. The claimed subject matter, however, is not intended to be limited to the specific terminology so selected, and it is to be understood that each specific element includes all technical equivalents that operate in a similar manner to accomplish a similar purpose.

This written description uses examples to disclose the invention, including the best mode, and also to enable any person skilled in the art to practice the invention, including making and using any devices or systems and performing any incorporated methods. The patentable scope of the invention is defined by the claims and may include other examples that occur to those skilled in the art. Such other examples are intended to be within the scope of the claims if they have structural elements that do not differ from the literal language of the claims, or if they include equivalent structural elements with insubstantial differences from the literal languages of the claims. This written description uses examples to disclose the invention, including the best mode, and also to enable any person skilled in the art to practice the invention, including making and using any devices or systems and performing any incorporated methods. The patentable scope of the invention is defined by the claims and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed:

1. A computer system comprising:
one or more processors;
optionally a display configured to display images representative of an energy system;
a library of one or more device drivers, each of the one or more device drivers in the library configured to control a respective device;
a communication interface between the energy system and the one or more processors; and
at least one memory having stored therein instructions that, upon execution by the one or more processors, cause the computer system to perform operations comprising:
receiving a first input that activates a first design of the energy system, the first design of the energy system including a first set of devices; and
in response to receiving the first input, instantiating the device drivers from the library that correspond to the first set of devices to control, via the communication interface, the first set of devices in the first design of the energy system.

2. The computer system of claim 1, wherein the first input comprises a one line diagram that includes a plurality of images connected with each other, the plurality of images connected with each other representative of the first set of devices such that each device in the first set of devices is communicatively connected with other devices in the first set of devices in accordance with the one line diagram.

3. The computer system of claim 1, wherein the communication interface is configured to communicate with the first set of devices using a plurality of different communication protocols.

4. The computer system of claim 1, the at least one memory having stored therein further instructions that, upon execution by the one or more processors, cause the computer system to perform operations further comprising:
monitoring a set of handles corresponding to each device in the first set of devices; and
based on the set of handles that correspond to a first device in the first set of devices, linking the first device to a second device such that the one of the first and second devices is controlled by the other of the first and second devices.

5. The computer system of claim 1, the at least one memory having stored therein further instructions that, upon execution by the one or more processors, cause the computer system to perform operations further comprising:
receiving a second input; and
in response to the second input, adding a new driver, corresponding to a new device, to the library such that the new device can be implemented in the energy system.

6. The computer system of claim 1, the at least one memory having stored therein further instructions that, upon execution by the one or more processors, cause the computer system to perform operations further comprising:
monitoring the energy system; and
based on monitoring the energy system, displaying data indicative of a historical performance of the energy system.

7. The computer system of claim 1, wherein the plurality of images representative of the devices in the energy system include at least one of an energy meter image, a power inverter image, a power source image, or a control device image.

8. A computer-implemented method comprising:
displaying images representative of an energy system;
storing a library of one or more device drivers, each of the one or more device drivers in the library configured to control a respective device;
receiving a first input that activates a first design of the energy system, the first design of the energy system including a first set of devices; and
in response to receiving the first input, instantiating the device drivers from the library that correspond to the first set of devices to control, via a communication interface, the first set of devices in the first design of the energy system.

9. The method of claim 8, wherein the first input comprises a one line diagram that includes a plurality of images connected with each other, the plurality of images connected with each other representative of the first set of devices such that each device in the first set of devices is communicatively connected with one or more other devices in the first set of devices in accordance with the one line diagram.

10. The method of claim 8, wherein the communication interface is configured to communicate with the first set of devices using a plurality of different communication protocols.

11. The method of claim 8, the method further comprising:
monitoring a set of handles corresponding to each device in the first set of devices; and
based on the set of handles that correspond to a first device in the first set of devices, linking the first device to a second device such that the one of the first and second devices is controlled by the other of the first and second devices.

12. The method of claim 8, the method further comprising:
receiving a second input; and
in response to the second input, adding a new driver, corresponding to a new device, to the library such that the new device can be implemented in the energy system.

13. The method of claim 8, the method further comprising:
monitoring the energy system; and
based on monitoring the energy system, displaying data indicative of a historical performance of the energy system.

14. The method of claim 8, wherein the plurality of images representative of the devices in the energy system include at least one of an energy meter image, a power inverter image, a power source image, or a control device image.

15. One or more non-transitory computer-readable storage media having collectively stored thereon instructions that, upon execution by one or more processors of a computer system, cause the computer system to at least:
display images representative of an energy system;
store a library of one or more device drivers, each of the one or more device drivers in the library configured to control a respective device;
receive a first input that activates a first design of the energy system, the first design of the energy system including a first set of devices; and
in response to receiving the first input, instantiate the device drivers from the library that correspond to the first set of devices to control, via a communication interface, the first set of devices in the first design of the energy system.

16. The non-transitory computer-readable storage media as recited in claim 15, wherein the first input comprises a one line diagram that includes a plurality of images connected with each other, the plurality of images connected with each other representative of the first set of devices such that each device in the first set of devices is communicatively connected one or more other devices in the first set of devices in accordance with the one line diagram.

17. The non-transitory computer-readable storage media as recited in claim 15, wherein the communication interface is configured to communicate with the first set of devices using a plurality of different communication protocols.

18. The non-transitory computer-readable storage media as recited in claim 15, having further stored thereon instructions that, upon execution by the one or more processors of the computer system, cause the computer system to at least:
monitor a set of handles corresponding to each device in the first set of devices; and
based on the set of handles that correspond to a first device in the first set of devices, link the first device to a second device such that the one of the first and second devices is controlled by the other of the first and second devices.

19. The non-transitory computer-readable storage media as recited in claim 15, having further stored thereon instructions that, upon execution by the one or more processors of the computer system, cause the computer system to at least:
receive a second input; and
in response to the second input, add a new driver, corresponding to a new device, to the library such that the new device can be implemented in the energy system.

20. The non-transitory computer-readable storage media as recited in claim 15, having further stored thereon instructions that, upon execution by the one or more processors of the computer system, cause the computer system to at least:
monitor the energy system; and
based on monitoring the energy system, display data indicative of a historical performance of the energy system.

21. The non-transitory computer-readable storage media as recited in claim 15, wherein the plurality of images representative of the devices in the energy system include at least one of an energy meter image, a power inverter image, a power source image, or a control device image.
